(19) United States
(12) Patent Application Publication
(10) Pub. No.: US 2013/0269628 A1
(43) Pub. Date: Oct. 17, 2013

(54) PET COLLAR AND LOCKING SLIDE LENGTH ADJUSTER THEREFOR

(71) Applicant: COASTAL PET PRODUCTS, INC., Alliance, OH (US)

(72) Inventor: Robert C. HOLT, JR., North Canton, OH (US)

(73) Assignee: COASTAL PET PRODUCTS, INC., Alliance, OH (US)

(21) Appl. No.: 13/769,876

(22) Filed: Feb. 19, 2013

Related U.S. Application Data
(60) Provisional application No. 61/623,631, filed on Apr. 13, 2012.

(51) Int. Cl. A01K 27/00

(52) U.S. Cl. CPC A01K 27/001
USPC 119/792; 119/863

(57) ABSTRACT

A strap adjuster to adjust the length of a strap, such as used to form a pet collar, includes side rails and end rails defining a body. A central cross member and spaced ribs extend between the side rails, the central cross member, ribs, and end rails acting to define a plurality of openings. One side of the strap is looped around the central cross member and a second layer of the strap is passed into the strap adjuster through an opening between one rib and one end rail and passes out of the strap adjuster through an opening between the other rib and the other end rail. The ribs include notches or a textured upper surface to provide increased friction with a bottom surface of the strap.

### CROSS-REFERENCE TO RELATED APPLICATION

This application claims priority from U.S. Provisional Patent Application Ser. No. 61/623,631 filed on Apr. 13, 2012, which is incorporated herein by reference in its entirety.

### TECHNICAL FIELD

This invention relates to slide coupler for adjustable straps. More particularly, this invention relates to a slide coupler including one or more cross members, at least one of the cross members having a textured top surface to resist sliding of a strap.

### BACKGROUND ART

Slide couplers, also referred to as slide strap length adjusters, are well known in the art and they have utility in a wide range of applications. For example, slide couplers can be used on luggage, back packs, sporting equipment, child safety seats, and pet products such as collars and harnesses. Known strap length adjusters typically include a generally rectangular body with a single cross member extending longitudinally across the opening defined by the body. Other known slide adjusters have rounded bodies, and may be formed from wire or other materials. A looped end of a strap is secured around the cross member of the slide adjuster, and the strap doubles back so that a second layer of the strap is received over the cross member and the loop. A buckle or other connecting device is often located adjacent to the slide adjuster. Those skilled in the art will appreciate that the slide adjuster provides a mechanism for adjusting the effective length of the strap by changing the amount of the strap that is folded over upon itself.

One problem with known slide adjusters is that, when subjected to relatively high or repetitive forces, such as might be generated by a pet wearing a collar, they are prone to slipping. In the case of a dog collar, such slippage could allow the pet to extricate itself from the collar. This is particularly true in instances where the strap or a portion of the strap includes low friction materials.

Thus, there is a need for an improved slide adjuster that alleviates one or more of the deficiencies of the prior art.

### DISCLOSURE OF THE INVENTION

It is thus an object of one aspect of the present invention to provide a slide adjuster that will not slip when positioned on a strap.

It is an object of another aspect of the present invention to provide a slide adjuster, as above, that when positioned on a pet collar will withstand the repetitive forces placed thereon by the pet.

These and other objects of the present invention, as well as the advantages thereof over existing prior art forms, which will become apparent from the description to follow, are accomplished by the improvements hereinafter described and claimed.

In general, a pet collar includes a strap and a device for adjusting the length of said strap. The device includes spaced side rails, spaced end rails extending between the ends of the side rails, a cross member extending between the side rails and spaced from the end rails, and a rib extending between the side rails and spaced from one of the end rails and from the cross member. A first portion of the strap extends around the cross member and a second portion of the strap extends slidably through the space between the rib and the one of said end rails and extends out of the device.

In accordance with another aspect of the invention, a pet collar includes a strap and a device for adjusting the length of the strap. The device includes first and second spaced side rails, a first end rail ending from one end of the first side rail to one end of the second side rail, a second end rail extending from the other end of the first side rail to the other end of the second side rail, a cross member extending between the side rails, and first and second ribs extending between the side rails. The cross member and the first and second ribs are positioned so as to form a first opening between the first end rail and the first rib, a second opening between the first rib and the cross member, a third opening between the cross member and the second rib, and a fourth opening between the second rib and the second end rail. One portion of the strap extending through the second and third openings and around the cross member, and a second portion of the strap extends slidably through the first and fourth openings.

As another aspect of the invention, a device which is adapted to receive a strap includes spaced side rails, spaced end rails extending between the ends of the side rails, a cross member extending between the side rails and being spaced from the end rails, and a rib extending between the side rails and being spaced from one of the end rails and spaced from the cross member.

In accordance with another aspect of the invention, in the combination of a strap and a device for adjusting the length of the strap, the device includes spaced side rails and spaced end rails extending between the ends of the side rails. A cross member extends between the side rails and is spaced from the end rails. A rib extends between the side rails and is spaced from one of the end rails and from the cross member. A first portion of the strap extends around the cross member and a second portion of the strap extends slidably through the space between the rib and the one end rails and extends out of the device.

A preferred exemplary slide adjuster and pet collar according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a pet collar of the present invention having a strap adjuster made in accordance with the concepts of the present invention.

FIG. 2 is another perspective view of the collar of FIG. 1.

FIG. 3 is a sectional view taken circumferentially along the collar of FIG. 2 substantially along line 3-3 thereof.

FIG. 4 is a top perspective view of the strap adjuster of the present invention.

FIG. 5 is a bottom perspective view of the strap adjuster of FIG. 4.

FIG. 6 is a top plan view of the strap adjuster of FIG. 4.

FIG. 7 is a bottom plan view of the strap adjuster of FIG. 4.

FIG. 8 is a sectional view taken substantially along line 8-8 of FIG. 6.

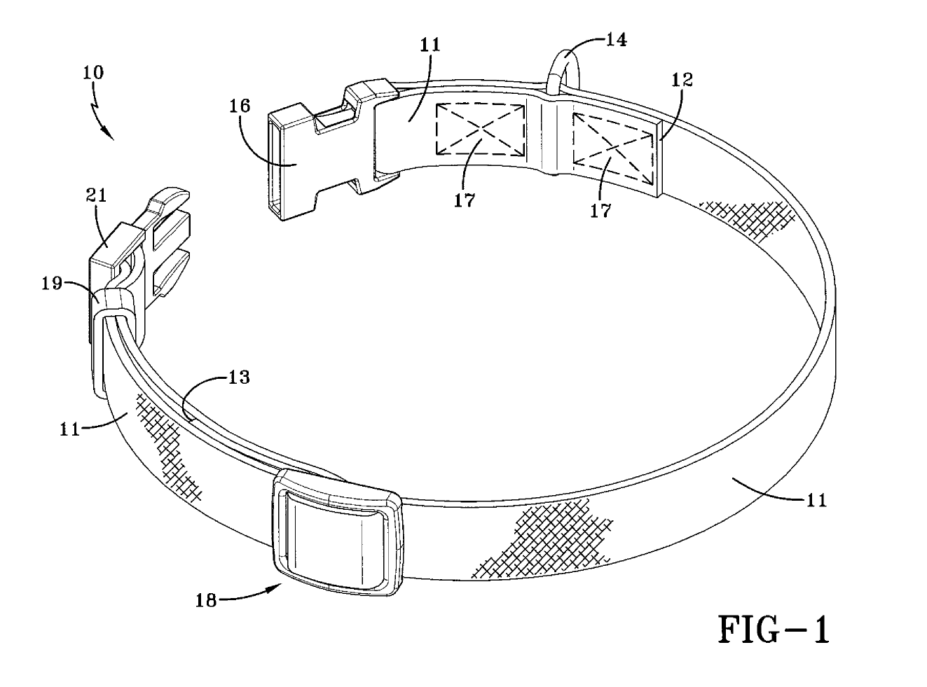

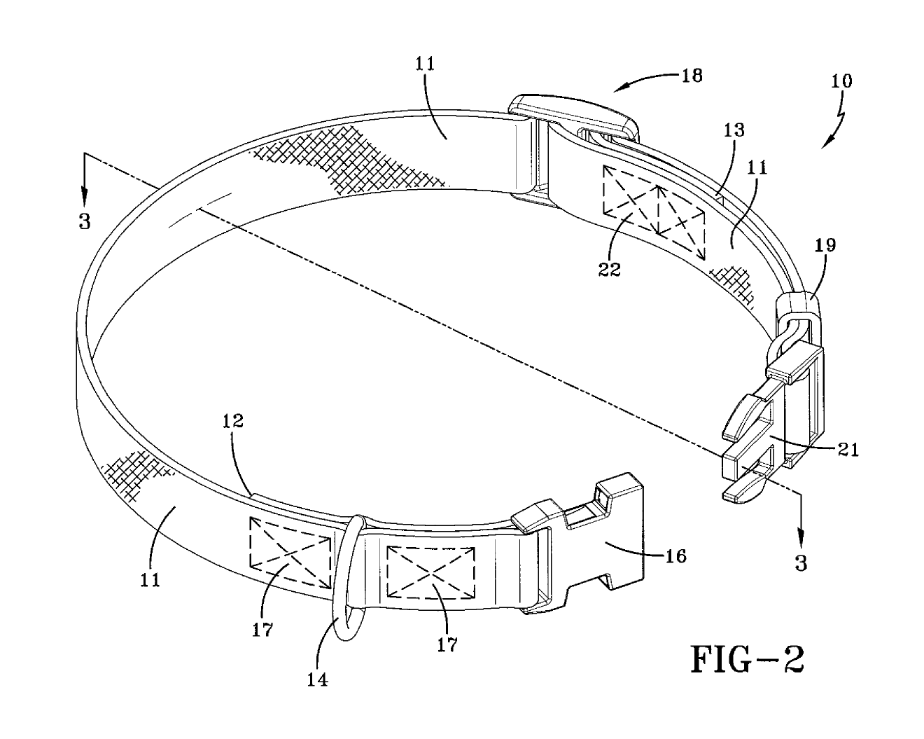

### PREFERRED EMBODIMENT FOR CARRYING OUT THE INVENTION

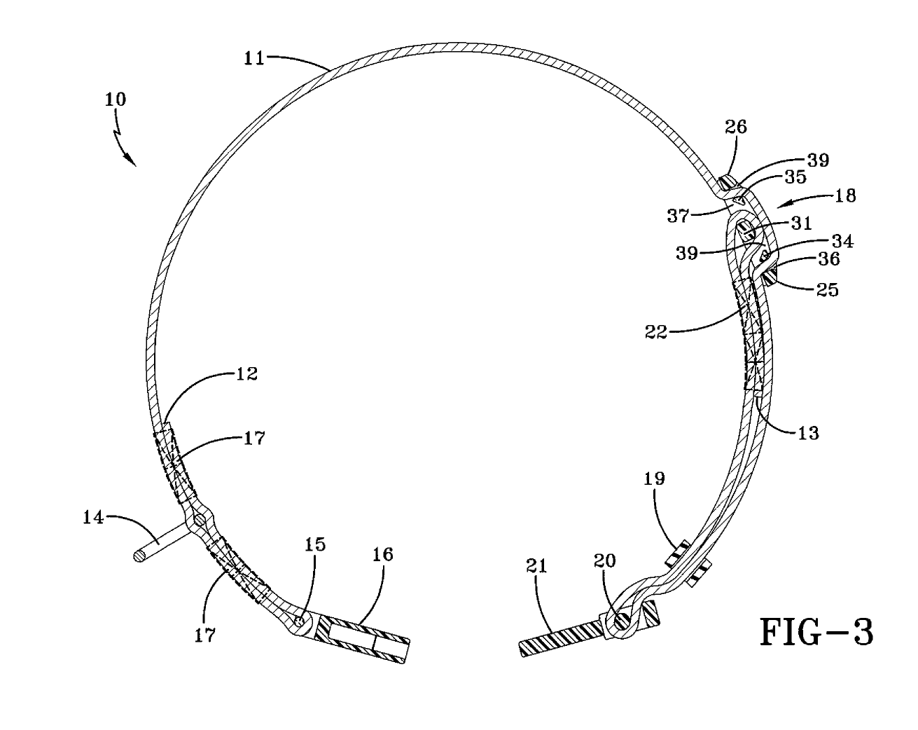

A collar for a pet is generally indicated by the numeral 10. Collar 10 includes a strap 11 which is preferably formed of one continuous piece of material, such as nylon, leather, or the like, having a first end 12 and a second end 13 as best shown in FIG. 3. Strap 11 extends from first end 12 past one side of a leash connector 14 and then around a post 15 of the female end 16 of a conventional quick release coupler. From post 15, strap 11 extends around the other side of leash connector 14 and it is stitched back on itself, as at 17, on both sides of leash connector 14 to maintain it in place.

Strap 11 then continues and is received by a strap adjuster made in accordance with the present invention and generally indicated by the number 18. The details 18 regarding the manner in which strap adjuster 18 engages strap 11 will be hereinafter discussed in conjunction with the detailed description of strap adjuster 18. Strap 11 continues from strap adjuster 18 through a keeper 19 and around a post 20 of the male end 21 of the quick release coupler. From post 20, strap 11 extends back through keeper 19 and again engages strap adjuster 18 in a manner to be described. Thus, between strap adjuster 18 and the male end 21 of the coupler, strap 11 is folded over itself, and as will hereinafter be described, it is the length of this fold which determines the length of the collar and which is changed by strap adjuster 18. Strap 11 ends, at 13, after it leaves strap adjuster 18, and end 13 is stitched or otherwise attached to the portion of strap 11 entering strap adjuster 18, as at 22.

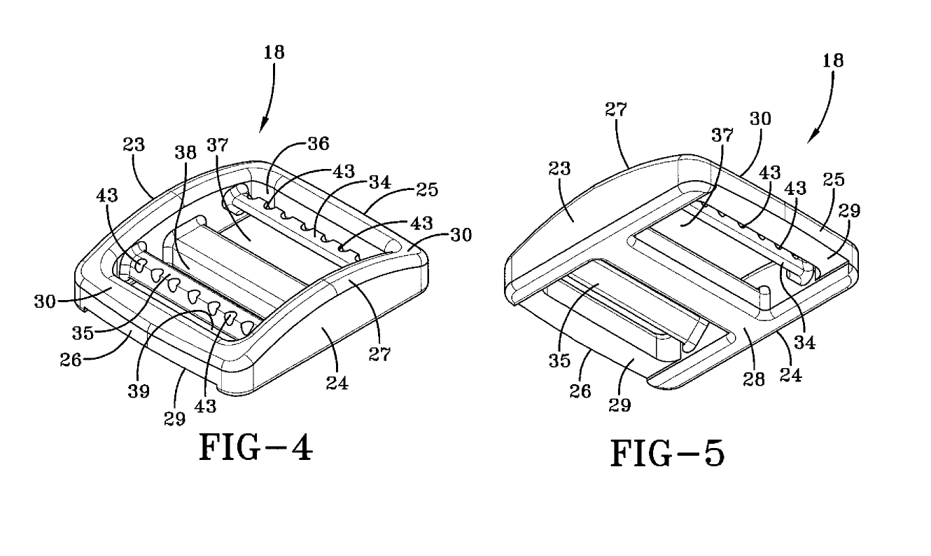

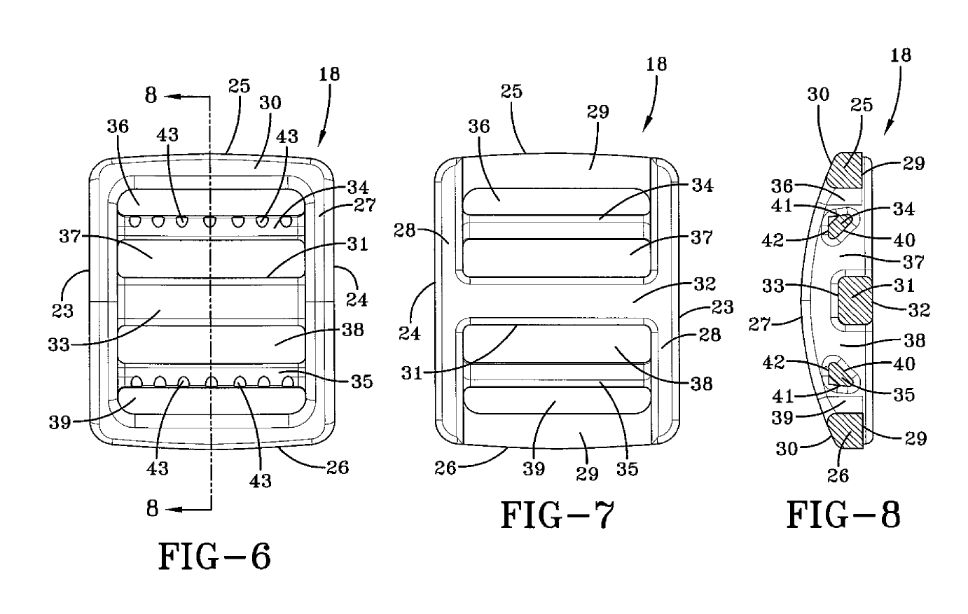

The details of strap adjuster 18 are shown in FIGS. 4-8, now to be described. Strap adjuster 18 is shown as being generally square or rectangular in configuration, and may be formed from any suitable material known to those skilled in the art. In certain embodiments, slide adjuster 18 may be formed at least in part from a plastic material and in other embodiments, slide adjuster 18 may also be formed at least in part from suitable metal stampings or castings.

Strap adjuster 18 includes first and second side rails 23 and 24, respectively, extending generally parallel to each other, and first and second end rails 25 and 26, respectively, extending generally parallel to each other between the first and second side rails 23 and 24. Thus, side rails 23 and 24 and end rails 25 and 26 form the generally square or rectangular body of strap adjuster 18. The outer and inner corners of the body, at the intersection of the side rails 23 and 24 and end rails 25 and 26, may be rounded to reduce the sharp edges and corners on the strap adjuster 18.

In certain embodiments, the first and second side rails 23 and 24 may each have an arched or radiused top surface 27 and a generally planar bottom surface 28. The first and second end rails 25 and 26 may each have a generally planar bottom surface 29 that is positioned on a plane displaced upwardly from the planar bottom surface 28 of the first and second side rails 23 and 24. As will be appreciated by those skilled in the art, the upward spacing of the bottom surfaces 29 of end rails 25, 26 allows for a strap 11 extending through the strap adjuster to be oriented generally linearly when tension is applied to the strap. The first and second end rails 25 and 26 may have a generally square or rectangular sectional profile with the top surface 30 of the first and second end rails 25 and 26 being radiused similar to the radius top surface 27 of the first and second side rails 23 and 24 to provide a continuously radiused upper surface on the top of the body of the strap adjuster 18.

A central cross member 31 extends between the first side rail 23 and second side rail 24 at the approximate mid point of the strap adjuster 18. The central cross member 31 may have a generally rectangular sectional profile and may be wider than it is tall. In certain embodiments, the central cross member 31 may have a generally planar bottom surface 32 that is coplanar with the planar bottom surface 28 of the first and second side rails 23 and 24. The central cross member 31 may also include a top surface 33 which is generally planar.

Strap adjuster 18 also includes a first rib 34 and preferably a second rib 35 extending between first and second side rails 23 and 24. The first rib 34 is positioned between central cross member 31 and first end rail 25, and the second rib 35 is positioned between central cross member 31 and second end rail 26. First and second ribs 34 and 35 may be spaced approximately the same distance from the central cross member 31.

As is apparent from the drawings, first and second end rails 25 and 26, first and second ribs 34 and 35, and central cross member 31 act to define a plurality of openings. A first opening 36 extends between the first end rail 25 and the first rib 34, a second opening 37 extends between the first rib 34 and the central cross member 31, a third opening 38 extends between the central cross member 31 and the second rib 35, and a fourth opening 39 extends between the second rib 38 and the second end rail 18.

Each of the first and second ribs 34 and 35 may have a generally triangular sectional profile, as best shown in FIG. 8. An angled surface 40 of each of the first and second ribs 34 and 35 faces the central cross member 31. An outer surface 41 and an upper surface 42 extend from opposing edges of the angled surface 40 and are approximately perpendicular to one another. A plurality of notches 43 may be provided in the outer surface 41 and/or upper surface 42 to create an irregular or textured surface for engagement with a strap positioned over the rib 34 or 35. In certain embodiments, the notches 43 may be radiused or curved to create a surface that is wavy. While the embodiments shown and described includes notches, it is also contemplated that protrusions may be provided on the first and second ribs 34 and 35 to create a textured surface for engagement with the bottom of a strap.

The manner in which the strap adjuster 18 is attached to strap 11 is best shown in FIG. 3. Strap 11 extends from end 13 and loops around central cross member 31 by extending through opening 37, over its top surface 33 and through opening 38. As previously described, strap 11 is then attached to itself by stitching 22 or by any other suitable means. On the other side of strap adjuster 18, the strap which extends from end 12 passes through the first opening 36 of strap adjuster 18, passes over the first and second ribs, 34 and 35, and out through the fourth opening 39. Such forms a second layer of strap 11 which is positioned over the first layer that engages cross member 31.

Thus, the bottom surface of the second layer of the strap 11 engages the outer surface 41, upper surface 42 and notches 43 of the first and second ribs 34 and 35. The textured surface or notches 43 on the first and second ribs 34 and 35 acts to provide increased friction between the strap adjuster 18 and the strap 11 to prevent undesired or unintentional movement of the strap 11 and strap adjuster 18.

The strap adjuster 18 as disclosed herein may be useful not only for pet collars but also for all types of adjustable straps. In particular, it is useful when used in conjunction with straps including low friction materials. For example, when a strap adjuster 18 is provided on a strap having a reflective top surface and a non-reflective bottom surface, the textured surface or notches 43 of the ribs 34 and 35 engage the non-reflective bottom surface so as to provide a higher degree of friction.

As previously described, strap adjuster 18 is utilized to provide an adjustment to the length of the strap 11, but does so without allowing any slippage due to tension placed on the strap. For example, tension on the strap on both sides of strap adjuster 18 causes the second layer of strap 11 to tighten down on ribs 34 and 35. However, to adjust the length of the strap 11 and make it shorter, the second layer of strap 11 on the strap adjuster 18 can be grasped to pull to strap 11 on the side of strap adjuster 18 adjacent to end 12 through first opening 36 thereby forming a loop in the second layer. Then by pulling on the strap 11 adjacent to male end 21 of the coupler, strap adjuster 18 is moved counter-clockwise in FIG. 3 along the strap, and the length of double strap between strap adjuster 18 and the male end 21 of the connector is increased thereby decreasing the length of collar 10. Conversely, if it is desired to make collar 10 larger, the amount of the doubled strap between strap adjuster 18 and male end 21 must be decreased. This is accomplished by feeding strap 11 up through opening 39 to form a loop in the second layer and pulling on the female end 16 side of the strap to ultimately move strap adjuster 18 clockwise in FIG. 3 along the strap 18.

It is thus evident that a strap connect constructed as described herein, especially when used on a pet collar or the like, accomplishes the objects of the present invention and otherwise substantially improves the art.

What is claimed is:

1. A pet collar comprising a strap and a device for adjusting the length of said strap, said device including spaced side rails, spaced end rails extending between the ends of said side rails, a cross member extending between said side rails and spaced from said end rails, and a rib extending between said side rails and spaced from one of said end rails and from said cross member, a first portion of said strap extending around said cross member and a second portion of said strap extending slidably through the space between said rib and said one of said end rails and extending out of said device.

2. The pet collar of claim 1 wherein said device further includes a second rib extending between said side rails and spaced from the other of said end rails and from said cross member, said second portion of said strap extending slidably through the space between said second rib and said other of said end rails as said strap extends out of the device.

3. The pet collar of claim 2 wherein the surface of said rib and of said second rib which engages said strap is textured.

4. The pet collar of claim 3 wherein a plurality of notches make up said textured surfaces.

5. The pet collar of claim 2 wherein said second portion of said strap includes an area which is adjacent to an area of said first portion of said strap, the length of said areas defining the length of said strap.

6. A pet collar comprising a strap and a device for adjusting the length of said strap, said device including first and second spaced side rails, a first end rail ending from one end of said first side rail to one end of said second side rail, a second end rail extending from the other end of said first side rail to the other end of said second side rail, a cross member extending between said side rails, first and second ribs extending between said side rails, said cross member and said first and second ribs being positioned so as to form a first opening between said first end rail and said first rib, a second opening between said first rib and said cross member, a third opening between said cross member and said second rib, and a fourth opening between said second rib and said second end rail, one portion of said strap extending through said second and third openings and around said cross member, and a second portion of said strap extending slidably through said first and fourth openings.

7. The pet collar of claim 6 wherein the surface of said ribs which engages said strap is textured.

8. The pet collar of claim 7 wherein a plurality of notches make up said textured surfaces.

9. The pet collar of claim 6 wherein an area of said one and second portions of said strap are adjacent to each other, said device being movable to adjust the length of said area and the length of said strap.

10. Apparatus adapted to receive a strap comprising spaced side rails, spaced end rails extending between the ends of said side rails, a cross member extending between said side rails and being spaced from said end rails, and a rib extending between said side rails and being spaced from one of said end rails and spaced from said cross member.

11. The apparatus of claim 10 further comprising a second rib extending between said side rails and being spaced from the other of same end rails and spaced from said cross member.

12. The apparatus of claim 11 wherein a surface of said ribs is textured.

13. The apparatus of claim 12 wherein a plurality of notches make up the textured surface.

14. The apparatus of claim 11 wherein a first opening is formed between said one of said end rails and said rib, a second opening is formed between said rib and said cross member, a third opening is formed between said cross member and said second rib, and a fourth opening is formed between said second rib and said other of said rails, said second and third openings being adapted to receive a portion of the strap around said cross member, and said first and fourth openings being adapted to receive another portion of the strap adjacent to said portion of the strap.

15. In combination, a strap and a device for adjusting the length of the strap, the device including spaced side rails, spaced end rails extending between the ends of said side rails, a cross member extending between said side rails and spaced from said end rails, and a rib extending between said side rails and spaced from one of said end rails and from said cross member, a first portion of the strap extending around said cross member and a second portion of the strap extending slidably through the space between said rib and said one of said end rails and extending out of the device.

16. The combination of claim 15 wherein the device further includes a second rib extending between said side rails and spaced from the other of said end rails and from said cross member, said second portion of the strap extending slidably through the space between said second rib and said other of said end rails as the strap extends out of the device.

17. The combination of claim 16 wherein the surface of said rib and of said second rib which engages the strap is textured.

18. The combination of claim 17 wherein a plurality of notches make up said textured surfaces.

19. The combination of claim 16 wherein said second portion of the strap includes an area which is adjacent to an area of said first portion of the strap, the length of said areas defining the length of the strap.
